(19) United States
(12) Patent Application Publication
(10) Pub. No.: US 2019/0382630 A1
(43) Pub. Date: Dec. 19, 2019

(54) HOT MELT ADHESIVE COMPOSITIONS INCLUDING MULTIPLE PROPYLENE POLYMERS, AND ARTICLES INCLUDING THE SAME

(71) Applicant: H.B. Fuller Company, St. Paul, MN (US)

(72) Inventors: Haiying Zhou, Arden Hills, MN (US); Kevin P. Davis, Woodbury, MN (US); Carlos Briseno, St. Paul, MN (US); Yuanyan Gu, Shanghai (CN)

(21) Appl. No.: 16/438,930

(22) Filed: Jun. 12, 2019

Related U.S. Application Data
(60) Provisional application No. 62/684,393, filed on Jun. 13, 2018.

(51) Int. Cl. C09J 123/14; C08F 210/06

(52) U.S. Cl. CPC C09J 123/142; C08K 5/0016; C08F 210/06

(57) ABSTRACT

A hot melt adhesive composition that includes at least 5% by weight of a first amorphous alpha-olefin copolymer derived from propylene and at least one olefin comonomer other than propylene, the first amorphous alpha-olefin copolymer having a viscosity of less than 50,000 cP at 190° C., from 1% by weight to 20% by weight of a second polyolefin derived from propylene and optionally an alpha-olefin comonomer, the second polyolefin exhibiting a heat of fusion from 15 Joules per gram (J/g) to no greater than 90 J/g, a third polyolefin derived from propylene and optionally an alpha-olefin comonomer other than propylene, the third polyolefin being different from the first amorphous alpha-olefin copolymer and the second polyolefin and exhibiting a melt flow rate of no greater than 100 grams/10 minute and a density of no greater than 0.880 g/cm³, tackifying agent, and liquid plasticizer.

### BACKGROUND

The invention is directed to formulating hot melt adhesive compositions that exhibit good static peel.

Hot melt adhesives are often used in the manufacture of disposable absorbent articles, such as diapers and feminine hygiene articles. Such hot melt adhesives are often referred to as construction adhesives, because they are used in the construction of the absorbent article. In the manufacture of disposable diapers, for example, hot melt construction adhesives are used to bond a polymer film back sheet to a nonwoven web top sheet. Hot melt adhesive compositions must exhibit certain properties to be commercially useful as construction adhesives. These properties include good adhesion, good mechanical strength, and good cohesive strength.

In the past, amorphous alphaolefin copolymers and semi-crystalline polymers have been used to formulate hot melt adhesive compositions. Amorphous alphaolefin copolymers are more tacky than semi-crystalline polymers; however, if used by themselves, they tend to lack the level of mechanical and cohesive strength required for certain hot melt adhesive applications.

Hot melt adhesive compositions that include high levels of crystalline components often do not form good adhesive bonds when applied at low coat weights. Higher coat weights can result in higher product cost and, in some applications, a higher coat weight can negatively impact a product's properties. In addition, semi-crystalline polymers that have a crystallinity of at least 40% tend to be brittle and often do not form good adhesive bonds.

There is a need for alternative hot melt adhesive compositions that exhibit good adhesion, good mechanical strength, good cohesive strength, and good peel properties.

### SUMMARY

In one aspect, the invention features a hot melt adhesive composition that includes at least 5% by weight of a first non-single site catalyzed amorphous alpha-olefin copolymer derived from propylene and at least one olefin comonomer other than propylene, the first amorphous alpha-olefin copolymer having a viscosity of less than 50,000 cP at 190° C., from 1% by weight to 20% by weight of a second polyolefin derived from propylene and optionally an alpha-olefin comonomer, the second polyolefin exhibiting a heat of fusion from 15 Joules per gram (J/g) to no greater than 90 J/g, a third polyolefin derived from propylene and optionally an alpha-olefin comonomer other than propylene, the third polyolefin being different from the first amorphous alpha-olefin copolymer and the second polyolefin, and exhibiting a melt flow rate of no greater than 100 grams/10 minute (g/10 min) and a density of no greater than 0.880 g/cm³, tackifying agent, and liquid plasticizer.

In one embodiment, the hot melt adhesive composition includes from 5% by weight to 40% by weight of the first amorphous alpha-olefin copolymer, from 1% by weight to 20% by weight of the second polyolefin, and from 5% by weight to 20% by weight of the third polyolefin.

In another embodiment, the hot melt adhesive composition includes from 1% by weight to 20% by weight of the plasticizer. In other embodiments, the hot melt adhesive composition includes from 1% by weight to 17% by weight of the plasticizer.

In some embodiments, the third polyolefin exhibits a melt flow rate of no greater than 50 g/10 min. In other embodiments, the third polyolefin exhibits a melt flow rate of greater than 15 g/10 min to no greater than 50 g/10 min.

In other embodiments, the hot melt adhesive composition exhibits a static peel of at least 10 minutes. In another embodiment, the hot melt adhesive composition exhibits a static peel of at least 20 minutes.

In one embodiment, the hot melt adhesive composition exhibits a dynamic peel of at least 20 g force/cm (gf/cm) and a static peel of at least 10 minutes. In another embodiment, the hot melt adhesive composition exhibits a dynamic peel of at least 20 gf/cm and a static peel of at least 20 minutes. In some embodiments, the hot melt adhesive composition exhibits a dynamic peel of at least 25 gf/cm.

In other embodiments, the hot melt adhesive composition exhibits a viscosity of no greater than 10,000 centipoise (cP) at 150° C.

In another embodiment, the third polymer is derived from 10% by weight to 20% by weight ethylene.

In some embodiments, the third polymer has a density of no greater than 0.870 g/cm³.

In one embodiment, the second polymer exhibits a viscosity no greater than 10,000 cP at 190° C.

In one embodiment, the first polymer exhibits a viscosity from 500 cP to 20,000 cP at 190° C.

In another aspect, the invention features a hot melt adhesive composition that includes at least 5% by weight, or even at least 15% by weight, of a first amorphous alpha-olefin copolymer derived from propylene and at least one olefin comonomer other than propylene, the first amorphous alpha-olefin copolymer having a viscosity of less than 50,000 cP at 190° C. and a heat of fusion of no greater than 10 Joules per gram (J/g), from 1% by weight to 20% by weight of a second polyolefin derived from propylene and optionally an alpha-olefin comonomer, the second polyolefin exhibiting a heat of fusion from 15 Joules per gram (J/g) to no greater than 90 J/g, a third polyolefin derived from propylene and optionally an alpha-olefin comonomer other than propylene, the third polyolefin being different from the first amorphous alpha-olefin copolymer and the second polyolefin, and exhibiting a melt flow rate of no greater than 100 grams/10 minute (g/10 min) and a density of no greater than 0.880 g/cm³, tackifying agent, and liquid plasticizer.

In other aspects, the invention features a disposable absorbent article that includes a back sheet, a hot melt adhesive composition disclosed herein, and a top sheet adhered to the back sheet through the hot melt adhesive composition.

The invention features a hot melt adhesive composition that exhibits good peel adhesion, including good static peel adhesion, at a low coat weight.

Other features and advantages will be apparent from the following description of the preferred embodiments and from the claims.

### Glossary

In reference to the invention, these terms have the meanings set forth below:

The term “amorphous” as used in reference to a polymer means a polymer having a heat of fusion no greater than 14 Joules per gram (J/g).

### DETAILED DESCRIPTION

The hot melt adhesive composition includes a first amorphous alpha-olefin copolymer, a second polyolefin, a third polyolefin, tackifying agent, and liquid plasticizer. The hot melt adhesive composition exhibits a static peel of at least 10 minutes (min), at least 25 min, at least 40 min, at least 50 min, at least 70 min, at least 100 min or even at least 200 min at 37° C. The hot melt adhesive composition preferably exhibits a dynamic peel of at least 20 gf/cm, at least 25 gf/cm, at least 30 gf/cm, at least 35 gf/cm, or even at least 40 gf/cm. The hot melt adhesive composition also exhibits a viscosity of at least 1500 centipoise (cP), no greater than 20,000 cP, no greater than 15,000 cP, no greater than 10,000 cP, or even no greater than 8000 cP at 163° C., or even at 149° C.

First Amorphous Alpha-Olefin Copolymer

The amorphous alpha-olefin copolymer is derived from propylene and at least one olefin comonomer other than propylene. The amorphous alpha-olefin copolymer also has a density of no greater than 0.90 g/cm³, exhibits a glass transition temperature (Tg) of no greater than 0° C., no greater than −5° C., no greater than −10° C., no greater than −15° C., or even no greater than about −25° C., and exhibits a melt temperature (Tm) of no greater than 130° C., no greater than 125° C., or even no greater than 120° C. Useful amorphous alpha-olefin copolymers also exhibit a heat of fusion of no greater than 14 J/g, no greater than 12 J/g, or even no greater than 10 J/g, and a viscosity of at least 500 cP, at least 750 cP, at least 1000 cP, at least 3000 cP, less than 50,000 cP, no greater than 20,000 cP, from 3000 cP, to 50,000 cP, or even from 3000 cP to 20,000 cP at 190° C.

Useful amorphous alpha-olefin copolymers include, e.g., copolymers, terpolymers, higher order polymers, and combinations thereof, and are derived from propylene and at least one alpha-olefin comonomer other than propylene including, e.g., alpha-olefin monomers having at least two carbon atoms, at least four carbon atoms, from four carbon atoms to eight carbon atoms, and combinations thereof. The first amorphous alpha-olefin copolymer optionally includes a blend of at least two different amorphous alpha-olefin copolymers. Useful alpha-olefin monomers include, e.g., ethylene, butene, pentene, hexene, heptene, octene, nonene, decene, dodecene, 4-methyl-1-pentene, 3-methyl-1-pentene, 3,5,5-trimethyl-1-hexene, 5-ethyl-1-nonene, and combinations thereof. Suitable alpha-olefin comonomers also include mono-alpha olefins (i.e., one unsaturated double bond) and higher order olefins.

The amorphous alpha-olefin copolymer preferably is free of functional groups but optionally includes functional groups (e.g., maleic anhydride modified propylene-alpha-olefin polymer). The propylene-alpha-olefin copolymer also preferably has an acid number of zero.

The amorphous alpha-olefin copolymer can be prepared using a variety of catalysts including, e.g., a single site catalyst (e.g., a metallocene catalyst), a non-single site catalyst (e.g., a Ziegler Natta catalyst), and combinations thereof.

Useful amorphous alpha-olefin copolymers are commercially available under a variety of trade designations including, e.g., AERAFIN 180 and AERAFIN 17 propylene-ethylene copolymers, both of which are available from Eastman Chemical Co. (Kingsport, Tenn.), REXTAC 2730 and 2830 propylene-butene copolymers from Rextac, LLC (Odessa, Tex.), and VESTOPLAST V2094 and V 2103 ethylene-propylene-butene terpolymers from Evonik Resource Efficiency GmbH (Essen, Germany).

The hot melt adhesive composition includes at least 5% by weight, at least 10% by weight, at least 15% by weight, at least 20% by weight, no greater than 40% by weight, no greater than 35% by weight, no greater than 30% by weight, from 5% by weight to 35% by weight or even from 10% by weight to 30% by weight amorphous alpha-olefin copolymer.

Second Polyolefin

The second polyolefin is derived from propylene and optionally a comonomer. The second polyolefin exhibits a heat of fusion of from 15 J/g to no greater than 90 J/g, from 15 J/g to no greater than 50 J/g, from 15 J/g to 45 J/g, or even from 20 J/g to 45 J/g, and a melting point no greater than 130° C., no greater than 120° C., or even no greater than 110° C. The second polyolefin also exhibits a viscosity of at least 750 cP, no greater than 10,000 cP, no greater than 8,000 cP, no greater than 5,000 cP, or even no greater than 2,000 cP at 190° C. The second polyolefin preferably exhibits a glass transition temperature (Tg) of no greater than −10° C. or even no greater than −20° C. Useful second polyolefins exhibit a density of at least 0.86 g/cm³, a least 0.87 g/cm³, no greater than 0.90 g/cm³, from 0.86 g/cm³ to 0.90 g/cm³, or even from 0.87 g/cm³ to 0.89 g/cm³.

Useful second polyolefins include, e.g., copolymers (i.e., copolymer, terpolymer, and higher order polymers), homopolymers, and combinations. The second polyolefin optionally includes a blend of at least two different polyolefins. Useful second polyolefin copolymers are derived from propylene and a comonomer including, e.g., styrene, alpha-olefin monomer (e.g., alpha-olefin monomers having at least two carbon atoms, at least four carbon atoms, from four carbon atoms to eight carbon atoms, and combinations of such monomers), and combinations thereof. Examples of suitable classes of alpha-olefin co-monomers include mono-alpha olefins (i.e., one unsaturated double bond) and higher order alpha olefins. Useful alpha-olefin monomers include, e.g., ethylene, butene, pentene, hexene, heptene, octene, nonene, decene, dodecene, 4-methyl-1-pentene, 3-methyl-1-pentene, 3,5,5-trimethyl-1-hexene, 5-ethyl-1-nonene, and combinations thereof. Specific examples of suitable second polyolefins include polypropylene, propylene-alpha-olefin copolymers (e.g., propylene-ethylene, propylene-butene, propylene-hexene, propylene-octene, and combinations thereof), and combinations thereof.

The second polyolefin is derived from at least 5% by weight, at least 10% by weight, at least 25% by weight, at least 50% by weight at least 75% by weight, at least 80% by weight, 100% by weight, or even from 75% by weight to 100% by weight propylene. The second polyolefin optionally is additionally derived from no greater than 95% by weight, no greater than 90% by weight, no greater than 75% by weight, no greater than 50% by weight, no greater than 25% by weight, no greater than 20% by weight, 0% by weight, at least 5% by weight, at least 25% by weight, or even from 0% by weight to 25% by weight comonomer.

Useful second polyolefins are prepared using a variety of catalysts including, e.g., a single site catalyst (e.g., metallocene catalysts (e.g., metallocene-catalyzed propylene polymers)), multiple single site catalysts, non-metallocene heteroaryl catalysts, and combinations thereof.

Suitable second polyolefins are commercially available under a variety of trade designations including, e.g., VISTAMAXX 8880, VISTAMAXX 8780, and VISTAMAXX 8380 propylene-ethylene copolymers from ExxonMobil Chemical Company (Houston, Tex.) and LICOCENE propylene-ethylene copolymers from Clariant Int'l Ltd. (Muttenz, Switzerland) including, e.g., LICOCENE PP 1502 TP, PP 1602 TP, and PP 2602 TP.

The hot melt adhesive composition includes at least 1% by weight, at least 2% by weight, at least 5% by weight, no greater than 25% by weight, no greater than 20% by weight, from 1% by weight to about 20% by weight, or even from 2% by weight to about 15% by weight second polyolefin.

Third Polyolefin

The third polyolefin is different from the first amorphous polyolefin and the second polyolefin. The third polyolefin is derived from propylene and optionally a comonomer and exhibits a melt flow rate of at no greater than 100 g/10 min, no greater than 50 g/10 min, at least 10 g/10 min, or even from 10 g/10 min to 100 g/10 min at 230° C. when tested according to ASTM D-1238 using a 2.16 kg weight. Useful third polyolefins exhibit a density of at least 0.860 g/cm³, no greater than 0.880 g/cm³, or even no greater than 0.870 g/cm³.

Useful third polyolefins include, e.g., copolymers (i.e., copolymer, terpolymer, and higher order polymers), homopolymers, and combinations. The third polyolefin optionally includes a blend of at least two different polyolefins. Useful third polyolefin copolymers are derived from propylene and a comonomer including, e.g., styrene, alpha-olefin monomer (e.g., alpha-olefin monomers having at least two carbon atoms, at least four carbon atoms, from four carbon atoms to eight carbon atoms, and combinations of such monomers), and combinations thereof. Examples of suitable classes of alpha-olefin comonomers include mono-alpha olefins (i.e., one unsaturated double bond) and higher order alpha olefins. Useful alpha-olefin monomers include, e.g., ethylene, butene, pentene, hexene, heptene, octene, nonene, decene, dodecene, 4-methyl-1-pentene, 3-methyl-1-pentene, 3,5,5-trimethyl-1-hexene, 5-ethyl-1-nonene, and combinations thereof. Specific examples of suitable third polyolefins include polypropylene, propylene-alpha-olefin copolymers (e.g., propylene-ethylene, propylene-butene, propylene-hexene, propylene-octene, and combinations thereof), and combinations thereof.

Useful third polyolefins are derived from at least 5% by weight, at least 10% by weight, at least 25% by weight, at least 50% by weight at least 75% by weight, at least 80% by weight, at least 90% by weight, at least 100% by weight, or even from 75% by weight to 100% by weight propylene. The third polyolefin is optionally additionally derived from no greater than 95% by weight, no greater than 90% by weight, no greater than 75% by weight, no greater than 50% by weight, no greater than 25% by weight, no greater than 20% by weight, 0% by weight, at least 5% by weight, at least 10% by weight, or even from 10% by weight to 20% by weight comonomer. A particularly useful third polyolefin is derived from propylene and from 10% by weight to 20% by weight, from 10% by weight to 15% by weight or even from 10% by weight to 14% by weight ethylene.

Useful third polyolefins are prepared using a variety of catalysts including, e.g., a single site catalyst (e.g., metallocene catalysts (e.g., metallocene-catalyzed propylene polymers)), multiple single site catalysts, non-metallocene heteroaryl catalysts, and combinations thereof.

Suitable third polyolefins are commercially available under a variety of trade designations including, e.g., VISTAMAXX 6502 propylene-ethylene copolymer, which includes 13% ethylene, and VISTAMAXX 6202 propylene-ethylene copolymer, which includes 15% ethylene, both of which are commercially available from ExxonMobil Chemical Company (Houston, Tex.).

The hot melt adhesive composition includes at least 1% by weight, at least 2% by weight, no greater than 20% by weight, no greater than 15% by weight, no greater than 12% by weight, from 1% by weight to about 20% by weight, from 2% by weight to about 15% by weight, or even from 2% by weight to about 12% by weight third polyolefin.

Plasticizer

The plasticizer is liquid at room temperature. The term “liquid” as used in reference to the plasticizer means that the plasticizer exhibits a kinematic viscosity of no greater than 5000 Centistokes (CST) at 100° C. as determined according to ASTM D445 and a pour point of no greater than 30° C. as determined according to ASTM D97. Suitable classes of liquid plasticizers include, e.g., oils, and oligomeric and low molecular weight polymeric plasticizers that are liquid at room temperature (hereinafter the oligomeric and low molecular weight polymeric plasticizers are referred to as “synthetic liquid plasticizers”). The polymeric and oligomeric liquid plasticizers preferably have a number average molecular weight (Mn) of from 500 g/mole to 7000 g/mole.

Useful plasticizers include, e.g., polybutene, polyisobutylene, polyolefin copolymers (e.g., propylene-ethylene copolymers), oligomerized alpha olefins, oils (e.g., naphthenic petroleum-based oils, paraffinic oils, mineral oils, animal oils, vegetable oils, synthetic oils, derivatives of oils, glycerol esters of fatty acids, and combinations thereof), and combinations thereof.

Useful plasticizers are commercially available under a variety of trade designations including, e.g., the INDOPOL series of trade designations from Ineos Oligomers Europe, Limited (Belgium) including INDOPOL H-300, H-1200, H-1500, H-1900, and H-2100 polybutenes, the DURASYN series of trade designations from Ineos Oligomers Europe including DURASYN 127 poly-1-decene, the TPC series of trade designations from TPC Group (Houston Tex.) including TPC 5230, TPC 1105, TPC1160, TPC 1285 and TPC 1350 polyisobutylenes, the LICOCENE series of trade designations from including, e.g., LICOCENE PPA 330 TP amorphous propylene-ethylene copolymer, KAYDOL mineral oil from Sonneborn (Tarrytown N.Y.), KRYSTOL 550 mineral oil from Petrochem Carless Limited (Surrey, England), and CALSOL 5550 naphthenic oil from Calumet Specialty Products Partners, LP (Indianapolis, Ind.).

The hot melt adhesive composition preferably includes at least 1% by weight, at least 5% by weight, no greater than 20% by weight, no greater than 18% by weight, no greater than 17% by weight, from 5.0% by weight to 17% by weight, or even from 10% by weight to 15% by weight liquid plasticizer.

Tackifying Agent

Useful tackifying agents have Ring and Ball softening point of less than about 140° C., less than about 130° C., or even less than about 120° C. The tackifying agent preferably includes aromaticity, or even from 5% by weight to 15% by weight aromatic groups. Suitable classes of tackifying agents include, e.g., aromatic, aliphatic and cycloaliphatic hydrocarbon resins, mixed aromatic and aliphatic modified hydrocarbon resins, aromatic modified aliphatic hydrocarbon resins, and hydrogenated versions thereof; terpenes, modified terpenes and hydrogenated versions thereof; and combinations thereof. Examples of useful polyterpene resins include polyterpene resins, hydrogenated polyterpene resins, and copolymers and terpolymers of natural terpenes (e.g. styrene-terpene, alpha-methyl styrene-terpene and vinyl toluene-terpene). Examples of useful aliphatic and cycloaliphatic petroleum hydrocarbon resins include aliphatic and cycloaliphatic petroleum hydrocarbon resins having Ring and Ball softening points of from about 10° C. to 140° C. (e.g., branched and unbranched C5 resins, C9 resins, and C10 resins) and hydrogenated derivatives thereof.

Useful tackifying agents are commercially available under a variety of trade designations including, e.g., the ESCOREZ series of trade designations from ExxonMobil Chemical Company (Houston, Tex.) including ESCOREZ 5400, ESCOREZ 5415, ESCOREZ 5600, ESCOREZ 5615, and ESCOREZ 5690, the EASTOTAC series of trade designations from Eastman Chemical (Kingsport, Tenn.) including EASTOTAC H-100R, EASTOTAC H-100L, and EASTOTAC H130W, the WINGTACK series of trade designations from Cray Valley HSC (Exton, Pa.) including WINGTACK 86, WINGTACK EXTRA and WINGTACK 95 and the PICCOTAC series of trade designations from Eastman Chemical Company (Kingsport, Tenn.) including, e.g., PICCOTAC 8095.

The hot melt adhesive composition preferably includes at least 25% by weight, at least 30% by weight, no greater than 55% by weight, no greater than 50% by weight, from 3.0% by weight to 55% by weight, or even from 35% by weight to 50% by weight tackifying agent.

Wax

The hot melt adhesive composition optionally includes wax. Suitable waxes include non-functionalized waxes, functionalized waxes, and combinations thereof. Examples of suitable non-functionalized waxes include polyolefin waxes (e.g., polypropylene waxes and polyethylene waxes), Fischer Tropsch waxes, paraffin waxes, microcrystalline waxes, metallocene waxes, and combinations thereof (e.g., a combination of two non-functionalized waxes each having a melting point of at least 115° C.). The hot melt adhesive composition preferably includes no greater than 10 by weight, no greater than 10% by weight, at least 1% by weight, or even from 1% by weight to 5% by weight wax.

Additional Components

The hot melt adhesive composition optionally includes additional components including, e.g., antioxidants, adhesion promoters, ultraviolet light stabilizers, rheology modifiers, biocides, corrosion inhibitors, dehydrators, colorants (e.g., pigments and dyes), fillers, surfactants, flame retardants, and combinations thereof.

Useful antioxidants include, e.g., pentaerythritol tetrakis[3,(3,5-di-tert-butyl-4-hydroxyphenyl)propionate], 2,2′-methylene bis(4-methyl-6-tert-butylphenol), phosphites including, e.g., tris-(p-nonylphenyl)-phosphite (TNPP) and bis(2,4-di-tert-butylphenyl)4,4′-diphenylene-diphosphonite, di-stearyl-3,3′-thiodipropionate (DSTDP), and combinations thereof. Suitable antioxidants are commercially available under a variety of trade designations including, e.g., the IRGANOX series of trade designations including, e.g., IRGANOX 1010, IRGANOX 565, and IRGANOX 1076 hindered phenolic antioxidants, and IRGAFOS 168 phosphite antioxidant, all of which are available from BASF Corporation (Florham Park, N.J.), and ETHYL 702 4,4′-methylene bis(2,6-di-tert-butylphenol). When present, the adhesive composition preferably includes from about 0.1% by weight to about 2% by weight antioxidant.

Uses

The hot melt adhesive composition is useful for bonding a variety of substrates to the same or different substrate including such substrates as polymeric back sheets, woven and nonwoven webs, elastomeric components (e.g., elastic strands, fibers, and filaments), fibers (synthetic fibers, cellulose fibers, and combinations thereof), polymer films (e.g., polyolefin (e.g., polyethylene, polypropylene, and combinations thereof), polyvinylidene chloride, ethylene vinyl acetate, polyester, metalized polymer, multi-layer, perforated films, elastomeric films, and combinations thereof), release liners, porous substrates, cellulose substrates, sheets (e.g., paper and fiber sheets), paper products, tape backings, and combinations thereof. The hot melt adhesive composition is also useful in a variety of processes used to bond a first substrate to a second substrate including, e.g. lamination processes (e.g., laminating porous substrates to polymer films, porous substrates to porous substrates, polymer films to polymer films, and combinations thereof).

The hot melt adhesive composition also is suitable for use in constructing a variety of disposable articles including, e.g., diapers, adult incontinence articles, feminine hygiene articles, medical dressings (e.g., wound care products), surgical pads, medical drapes, medical gowns, sheets, absorbent pads (e.g., meat packing products, animal pads (e.g., pet pads) and human pads (e.g., bodies and corpses)), and combinations thereof.

The hot melt adhesive composition can be applied to a substrate in any useful form including, e.g., a coating (e.g., a continuous or discontinuous coating), a film (e.g., a continuous or discontinuous film), in a pattern (a spray pattern), randomly, and combinations thereof, using any suitable application method including, e.g., slot coating, spray coating (e.g., spiral spray, random spraying, and random fiberization (e.g., melt blowing)), foaming, extrusion (e.g., applying a bead, fine line extrusion, single screw extrusion, and twin screw extrusion), wheel application, noncontact coating, contacting coating, gravure, engraved roller, roll coating, transfer coating, screen printing, flexographic, and combinations thereof.

The hot melt adhesive composition also can be applied to or incorporated in a variety of other substrates including, e.g., cardboard, coated cardboard, paperboard, fiber board, virgin and recycled kraft, high and low density kraft, chipboard, treated and coated kraft and chipboard, and corrugated versions of the aforementioned, clay coated chipboard carton stock, composites, leather, substrates made from cellulose fibers (e.g., virgin fibers, recycled fibers, and combinations thereof), and combinations thereof. The hot melt adhesive composition also can be applied to or incorporated in a variety of other articles including, e.g., composites (e.g., chipboard laminated to metal foil (e.g., aluminum foil), which optionally can be laminated to at least one layer of polymer film, chipboard bonded to film, kraft bonded to film, and combinations thereof), bags (e.g., multiwall bags), boxes, cartons, trays, cases, articles that include attachments (e.g., straws attached to drink boxes), ream wrap, cigarettes (e.g., plug wrap), filters (e.g., filter pleating and filter frames), and combinations thereof.

The invention will now be described by way of the following examples. All parts, ratios, percentages and amounts stated in the Examples are by weight unless otherwise specified.

### EXAMPLES

### Test Procedures

Test procedures used in the examples include the following. All ratios and percentages are by weight unless otherwise indicated. The procedures are conducted at room temperature (i.e., an ambient temperature of from about 20° C. to about 25° C.) unless otherwise specified.

### Glass Transition Temperature (Tg) and Melt Temperature (Tm) Test Method

Glass Transition Temperature (Tg) and Melt Temperature (Tm) are determined using differential scanning calorimetry (DSC) according to ASTM D-3418-99 entitled, “Transition Temperatures of Polymers by Thermal Analysis” and ASTM E-794-06 entitled, “Standard Test Method for Melting and Crystallization Temperatures by Thermal Analysis,” using the following conditions: quench cooling to −60° C., heating to 180° C. from −60° C. at a rate of 10° C. per minute, holding at 180° C. for 3 minutes (the first heating cycle), then cooling to −60° C. from 180° C. at a rate of 10° C. per minute, holding at −60° C. for 3 minutes, and then heating then from −60° C. to 180° C. at a rate of 10° C. per minute (the second heating cycle). Both Tg and Tm are obtained from the second heating cycle. The results are reported in degrees Celsius (° C.).

### Heat of Fusion Test Method

Heat of fusion (ΔH) is determined using differential scanning calorimetry according to ASTM E-793-06 entitled, “Standard Test Method for Enthalpies of Fusion and Crystallization by Differential Scanning Calorimetry,” using the following conditions: quench cooling to −60° C., heating to 180° C., from −60° C. at a rate of 10° C. per minute, holding at 180° C. for 3 minutes (the first heating cycle), then cooling to −60° C. from 180° C. at a rate of 10° C. per minute, holding at −60° C. for 3 minutes, and then heating then from −60° C. to 180° C. at a rate of 10° C. per minute (the second heating cycle). AH is obtained from the second heating cycle. The results are reported in Joules/gram (J/g).

### Viscosity Test Method

The viscosity of the hot melt adhesive composition is determined in accordance with ASTM D-3236 entitled, “Standard Test Method for Apparent Viscosity of Hot Melt Adhesives and Coating Materials,” (Oct. 31, 1988) using a Brookfield Thermosel Viscometer Model RVDV 2+ and an appropriate spindle. The results are reported in centipoise (“cP”).

### Melt Flow Rate Test Method

Melt flow rate is determined at 230° C. according to ASTM D-1238 using a 2.16 kg weight. The results are reported in units of grams per 10 minutes (g/10 min).

### Thermal Stability Test Method

A 200 gram sample of hot melt adhesive composition is placed in a glass beaker (uncovered) and conditioned in a temperature controlled, forced air oven at 163° C. for 100 hours. The molten sample is removed from the oven. The molten sample is observed for the presence of gel, surface skin formation, charring, and phase separation. The observations are recorded.

The sample is then tested according to the Viscosity test method and the measured viscosity is reported in centipoise.

Thermal stability is determined by change in viscosity and the presence or absence of charring, skinning or phase separation.

### Peel Test Sample Preparation Method

A patterned slot coating applicator, which is 3 inch (76.2 mm) wide, and a laminator are set to an application temperature of 154° C., a nip pressure of 103.4 kilopascal (15 psi), an application weight of 4 g/m², and minimal rewind and unwind tensions so as not to stretch the film. The hot melt adhesive composition is applied continuously at a coat weight of 4 g/m² on an oriented polypropylene nonwoven web having a thickness of 4 mil (0.1 mm) and a basis weight of 0.45 ouncers per square yard (15.3 g/m²) as the nonwoven web is passed through the applicator at a speed of from 173.7 meters per minute (m/min) to 192.0 m/min. An embossed non-breathable, layered polyethylene film having a thickness of 0.9 mil (0.23 mm), traveling at the same speed as the nonwoven web, is then nipped into place against the adhesive composition and the nonwoven web to form a laminate.

### Dynamic Peel Test Method

Dynamic Peel is determined according to ASTM D1876-01 entitled, “Test Method for Determining Peel Resistance of Adhesive (T-Peel Test Method),” with the exception that the test is run at 30.5 centimeters per minute (12 inches per minute) over a period of 10 seconds and 8 replicates are run. The samples are run on an IMASS Spec-type test instrument. Unless otherwise specified, the test samples are prepared as described in the Sample Preparation test method. The samples are peeled along the machine coating direction. The average peel value over 10 seconds of peeling is recorded, and the results are reported in grams. The initial Dynamic Peel value is the value measured 24 hours after the sample is prepared. Six replicates are tested and the average value is reported in units of grams of force per centimeter (gf/cm).

### Static Peel Test Method

Laminates are prepared according to the Peel Test Sample Preparation method. Test samples, 2 inch wide (50.8 mm), are cut from the laminates. The test samples are hung in an oven at 37° C. in a peel mode. A 30 g weight is placed on the sample. Samples are peeled in the cross-machine direction and the time to failure is measured. Five replicates are tested and the average time to fail is reported in minutes.

### Examples 1-8

Hot melt adhesive compositions of Examples 1-8 were prepared by combining the components in the amounts (in % by weight) specified in Table 1 and heating the same to from 175° C. to 190° C. with mixing.

The hot melt adhesive compositions of Examples 1-8 were then tested according to the Viscosity test method at 149° C., Dynamic Peel and Static Peel test methods and the results are reported in Table 1. The test samples used in the Dynamic Peel and Static Peel test methods were constructed with a UNIPRO 45 oriented polypropylene nonwoven web having a thickness of 4 mil (0.1 mm) and a basis weight of 0.45 ouncers per square yard (15.3 g/m2) from Midwest Filtration Company as the nonwoven web, and a XP34730 embossed non-breathable, layered polyethylene film back sheet having a thickness of 0.9 mil (0.23 mm) from Berry Global Inc. as the film.

TABLE 1

| | 1 | 2 | 3 | 4 | 5 | 6 | 7 | 8 |
|---|---|---|---|---|---|---|---|---|
| AERAFIN | 27.6 | 27.6 | 17.1 | 27.2 | 27.1 | 5.1 | 28.1 | 22.1 |
| 180¹ APAO | | | | | | | | |
| VISTAMAXX | 10.0 | 10.0 | 13.0 | 9.5 | 9.7 | 20.0 | 5.0 | 10.0 |
| 8880² | | | | | | | | |
| VISTAMAXX | 7.5 | 7.5 | 10.0 | 7.4 | 0 | 15.0 | 5.0 | 8.0 |
| 6502³ | | | | | | | | |
| VISTAMAXX | 0 | 0 | 0 | 0 | 6.8 | 0 | 0 | 0 |
| 6202⁴ | | | | | | | | |
| ESCOREZ | 0 | 0 | 43 | 35 | 35 | 43 | 48 | 43 |
| 5400⁵ | | | | | | | | |
| ESCOREZ | 36 | 0 | 0 | 0 | 0 | 0 | 0 | 0 |
| 5600⁶ | | | | | | | | |
| ESCOREZ | 0 | 36 | 0 | 0 | 0 | 0 | 0 | 0 |
| 1310⁷ | | | | | | | | |
| CALSOL | 15.0 | 15.0 | 13.0 | 17.0 | 17.5 | 13.0 | 11.5 | 14.5 |
| 5550⁸ | | | | | | | | |
| SX105⁹ | 2.0 | 2.0 | 2.0 | 2.0 | 2.0 | 2.0 | 2.0 | 2.0 |
| EPOLENE | 1.5 | 1.5 | 1.5 | 1.5 | 1.5 | 1.5 | 0 | 0 |
| C13¹⁰ | | | | | | | | |
| EVERNOX | 0.4 | 0.4 | 0.4 | 0.4 | 0.4 | 0.4 | 0.4 | 0.4 |
| 76¹¹ | | | | | | | | |
| Total | 100 | 100 | 100 | 100 | 100 | 100 | 100 | 100 |
| Viscosity at | 7,187 | 5,837 | 6,250 | 6,700 | 7,812 | 8,200 | 5,587 | 5,637 |
| 149° C. (cP) | | | | | | | | |
| Dynamic Peel | 42 | 43 | 27 | 39 | 37 | 21 | 42 | 34 |
| (g force/cm) | | | | | | | | |
| Static Peel | 75 | 15 | 108 | 41.2 | 50.6 | 215 | 59 | 29 |
| (min) | | | | | | | | |

¹= AERAFIN 180 propylene-ethylene copolymer (Eastman Chemical Co. Kingsport,Tennessee)
²= VISTAMAXX 8880 propylene-ethylene copolymer (ExxonMobil Chemical Co., Houston, Texas)
³= VISTAMAXX 6502 propylene-ethylene copolymer derived from 13% by weight ethylene (ExxonMobil Chemical Co., Houston, Texas)
⁴= VISTAMAXX 6202 propylene-ethylene copolymer derived from 15% by weight ethylene (ExxonMobil Chemical Co., Houston, Texas)
⁵= ESCOREZ 5400 cycloaliphatic hydrocarbon resin (ExxonMobil)
⁶= ESCOREZ 5600 aromatic modified, cycloaliphatic hydrocarbon resin (ExxonMobil)
⁷= ESCOREZ 1310 aliphatic hydrocarbon resin (ExxonMobil)
⁸= CALSOL 5550 naphthenic oil (Calumet Specialty Products Partners, LP, Indianapolis, Indiana)
⁹= SX105 Fischer Tropsch wax from Shell Malaysia Ltd. (Kuala Lumpur, Malaysia)
¹⁰= EPOLENE C-13 polyethylene wax (Westlake Chemical Corp., Houston, Texas)
¹¹= IRGANOX 76 hindered phenolic antioxidant (BASF Corp., Florham Park, New Jersey)

Other embodiments are within the claims. Documents referred to herein are hereby incorporated herein to the extent they do not conflict.

What is claimed is:

1. A hot melt adhesive composition comprising:
at least 5% by weight of a first non-single site catalyzed amorphous alpha-olefin copolymer derived from propylene and at least one olefin comonomer other than propylene, the first amorphous alpha-olefin copolymer having a viscosity of less than 50,000 cP at 190° C.;
from 1% by weight to 20% by weight of a second polyolefin derived from propylene and optionally an alpha-olefin comonomer, the second polyolefin exhibiting a heat of fusion from 15 Joules per gram (J/g) to no greater than 90 J/g;
a third polyolefin derived from propylene and optionally an alpha-olefin comonomer other than propylene, the third polyolefin being different from the first amorphous alpha-olefin copolymer and the second polyolefin, and exhibiting a melt flow rate of no greater than 100 grams/10 minute (g/10 min) and a density of no greater than 0.880 g/cm³;
tackifying agent; and
liquid plasticizer.

2. The hot melt adhesive composition of claim 1 comprising
from 5% by weight to 40% by weight of the first amorphous alpha-olefin copolymer,
from 1% by weight to 20% by weight of the second polyolefin, and
from 5% by weight to 20% by weight of the third polyolefin.

3. The hot melt adhesive composition of claim 1 comprising from 1% by weight to 20% by weight of the plasticizer.

4. The hot melt adhesive composition of claim 1 comprising from 1% by weight to 17% by weight of the plasticizer.

5. The hot melt adhesive composition of claim 2 comprising from 1% by weight to 17% by weight of the plasticizer.

6. The hot melt adhesive composition of claim 1, wherein the third polyolefin exhibits a melt flow rate of no greater than 50 g/10 min.

7. The hot melt adhesive composition of claim 1, wherein the third polyolefin exhibits a melt flow rate of greater than 15 g/10 min to no greater than 50 g/10 min.

8. The hot melt adhesive composition of claim 1, wherein the hot melt adhesive composition exhibits a static peel of at least 10 minutes.

9. The hot melt adhesive composition of claim 1, wherein the hot melt adhesive composition exhibits a static peel of at least 20 minutes.

10. The hot melt adhesive composition of claim 1, wherein the hot melt adhesive composition exhibits a dynamic peel of at least 20 g force/cm (gf/cm) and a static peel of at least 10 minutes.

11. The hot melt adhesive composition of claim 1, wherein the hot melt adhesive composition exhibits a dynamic peel of at least 20 gf/cm and a static peel of at least 20 minutes.

12. The hot melt adhesive composition of claim 1, wherein the hot melt adhesive composition exhibits a dynamic peel of at least 25 gf/cm.

13. The hot melt adhesive composition of claim 1, wherein the hot melt adhesive composition exhibits a viscosity of no greater than 10,000 centipoise (cP) at 150° C.

14. The hot melt adhesive composition of claim 1, wherein the third polymer is derived from 10% by weight to 20% by weight ethylene.

15. The hot melt adhesive composition of claim 1, wherein the third polymer has a density of no greater than 0.870 g/cm³.

16. The hot melt adhesive composition of claim 1, wherein the second polymer exhibits a viscosity no greater than 10,000 cP at 190° C.

17. The hot melt adhesive composition of claim 1, wherein the first polymer exhibits a viscosity from 500 cP to 20,000 cP at 190° C.

18. A disposable absorbent article comprising:
a back sheet;
the hot melt adhesive composition of claim 1; and
a top sheet adhered to the back sheet through the hot melt adhesive composition.

19. A hot melt adhesive composition comprising:
at least 15% by weight of a first amorphous alpha-olefin copolymer derived from propylene and at least one olefin comonomer other than propylene, the first amorphous alpha-olefin copolymer having a viscosity less than 50,000 cP at 190° C. and a heat of fusion of no greater than 10 Joules per gram (J/g);
from 1% by weight to 20% by weight of a second polyolefin derived from propylene and optionally an alpha-olefin comonomer, the second polyolefin exhibiting a heat of fusion from 15 Joules per gram (J/g) to no greater than 90 J/g;
a third polyolefin derived from propylene and optionally an alpha-olefin comonomer other than propylene, the third polyolefin being different from the first amorphous alpha-olefin copolymer and the second polyolefin, and exhibiting a melt flow rate of no greater than 100 grams/10 minute (g/10 min) and a density of no greater than 0.880 g/cm³;
tackifying agent; and
liquid plasticizer.
